(19) United States
(12) Patent Application Publication
(10) Pub. No.: US 2009/0207478 A1
(43) Pub. Date: Aug. 20, 2009

(54) Optical power limiting and switching combined device and a method for protecting imaging and non-imaging sensors

(76) Inventors: Ram Oron, Nes- Ziona (IL); Ariela Donval, Rosh-Ha'ain (IL); Doron Nevo, Ra'anana (IL); Moshe Oron, Rehovot (IL)

Correspondence Address: NIXON PEABODY, LLP, 300 S. Riverside Plaza, 16th Floor, CHICAGO, IL, 60606, US

(21) Appl. No.: 11/991,440

(22) PCT Filed: Nov. 10, 2006
(86) PCT No.: PCT/IB06/02834

§ 371 Date: Apr. 17, 2009

Related U.S. Application Data
(60) Provisional application No. 60/725,357, filed on Oct. 11, 2005.

(51) Int. Cl. G02F 1/01

(52) U.S. Cl. 359/297; 977/775; 977/834

(57) ABSTRACT

An optical power limiting and switching device comprises at least one plate made of transparent dielectric material, and a thin limiting solid mixture coated on one side of the plate. Upon being exposed to an optical power beam having a power level exceeding a predetermined limit power, the layer of solid mixture limits the power transmission by scattering out part of the impinging energy. When the power increases to the damage threshold, the solid mixture forms a plasma or catastrophic breakdown, damaging the solid mixture material and thereby rendering the portion of the plate surface under the impinging beam opaque to light.

### FIELD OF THE INVENTION

The present invention relates to optical power limiting and switching combined device and methods for protecting imaging and non-imaging sensors or other optical components. More particularly, the present invention concerns devices and methods for interrupting and/or limiting optical transmission in response to the transmission of predetermined, excessive optical power or energy, in order to protect imaging and non-imaging sensors, detectors or other optical components.

### BACKGROUND OF THE INVENTION

Imaging and detection systems, using large-aperture and low F-number telescopes, are susceptible to detector saturation and/or damage caused by a powerful light source or a high power laser within their fields of view. The problem exists in many cases, especially in modern optical systems wherein active (e.g., laser), together with passive (e.g., television or night-vision, multi-pixel) sensors are used in the same or adjacent systems, when reflected laser light or an arbitrary ray or reflection from a laser enters the imaging system. This difficulty calls for a passive device that will limit and/or switch-off the power propagating into the sensor or detector, when the power exceeds a maximal allowed intensity or a damaging threshold. Such a switching device should be placed either at the input of the sensitive optical detector or detector array, or on the optical path leading into the detector.

In the past, there have been attempts to realize such an optical safety switch, and efforts have been invested in optical imaging sights. The principles on which these prior art solutions were based included: (1) self-focusing or self-defocusing, due to a high electric field-induced index change through the third order susceptibility term of the optical material, and (2) reducing the optical quality of a gas or a solid transparent insert positioned at the focus or cross-over spot of a telescope, by creating a plasma in the cross-over point, whereby light is absorbed by the plasma. These solutions are described in U.S. Pat. Nos. 3,433,555, and 5,017,769, as well as in the IR/EO System Handbook, (ERIM, Vol. 7, p.p. 344-351).

U.S. Pat. No. 3,433,555 discloses a system in which plasma is formed in a gas, where the gas density is lower than solids and liquids and the density of the plasma formed by the gas is low as well, thus limiting its absorption to the medium and far infrared parts of the light spectrum. This device does not absorb in the visible and near infrared regions, and it cannot protect optical systems in these regions of the spectrum.

The system in U.S. Pat. No. 5,017,769 uses a solid, transparent insert in the cross-over point. The transparent insert is covered with carbon particles on its surface, enhancing the forming of plasma on the surface. Here, the plasma density is high, since it emanates from solid material. The dense plasma absorbs in the visible, as well as in the near, infrared light regions. The device is equipped with multiple inserts on a motorized rotating wheel, exposing a new, clean and transparent insert area after every damaging pulse. In this arrangement, the carbon does not endure over long exposures to high powers.

In the past, passive devices have been proposed for image display systems. These devices generally contain a mirror that is temporarily or permanently damaged by distortion or evaporation caused by an impinging high power laser beam. Examples of such devices are described in U.S. Pat. Nos. 6,384,982; 6,356,392; 6,204,974 and 5,886,822. The powers needed to operate the devices of these patents are in the range of pulsed or very energetic CW lasers. The distortion of a mirror by energy impinging upon it is very slow, and depends on the movement of the mirror's large mass and the absorbed energy that generates the movement. The process of reflective coating removal from large areas is also slow, since the mirror is not placed in the focus of the system, where the power is spatially concentrated.

Another passive device is disclosed in U.S. Pat. No. 6,216,581. In this device, two materials are used: the first material is heat-absorbing, while the second material is heat-degradable. When these materials are exposed to a light beam, the first material is heated and transfers its heat to the second one, whereupon the transparency or reflectivity of the second material is degraded, due to the high temperature. This process is relatively slow, since heat transfer times are long in comparison with laser pulses (usually laser pulses are down to the ns region), and in many cases, is not sufficiently quick to intercept the beam before damage occurs to objects along the optical line. In addition, the process of temperature-induced degradation does not provide enough opacity to efficiently prevent damage by high-power pulses.

The PCT patent application by KiloLambda OPTICAL POWER SWITCHING DEVICES AND A METHOD FOR PROTECTING IMAGING AND NON-IMAGING SENSORS PCT/IL03/01028 describes a protection system having the following properties:
(1) Transparent to image transfer in a broad light spectrum, without degradation of the image quality, under normal working conditions.
(2) When exposed to powers of a preset threshold and higher, the switch is fast enough to intercept damaging optical power before damage occurs.
(3) The part of the field of view, which is not exposed to threshold power, remains transparent.
(4) The permanent, opaque spot formed on the switch when it is exposed to high powers withstands long time exposures to damaging light, without change in its opacity.
(5) Opacity or transmission reduction of the filter is up to three orders of magnitude.
(6) The switch should react to both continuous and pulsed damaging lasers or lights.
(7) The switch should reacts to a wide range of spectral light sources or lasers.
(8) The switch reacts to a wide range of angles of impingement of the damaging light or laser.
   There is one additional important property that is an asset, and most of above switches do not have it, namely, recovery of the transparency after the exposure is over. This is one of the subjects of the present invention: a combined limiting and switching device.

### SUMMARY OF THE INVENTION

It is therefore a broad object of the present invention to provide a passive safety switch for protecting an imaging or non-imaging sensor or other optical components against powerful light sources and lasers in the field of view, that fulfills most of the above-described properties of an ideal switch and has limiting and recovery ability for powers between its limit power and its damage threshold power.

It is a further object of the present invention to provide a passive safety limiter and switch, as a part of an opto-electronic device, for protecting field optical systems, such as binoculars, monoculars, safety glasses and telescopes, or the human eye through safety goggles, against powerful light sources and lasers in the field of view.

It is a further object of the present invention to provide safety limiter and switch off devices and methods for interrupting or reducing optical transmission in response to the transmission of excessive optical power or energy, to be used for protecting imaging and non-imaging sensors or other optical components and to be installed either internally or at the input port of an optical imaging system.

A further object of the present invention is to provide a safety limiter and switch that has a predetermined value of an optical power limit and another, higher value, of optical damage threshold, for use in protection of imaging and non-imaging sensors or other optical components.

It is a still a further object of the present invention to provide a safety limiter and switch that is activated by a broad range of wavelengths, for use in imaging and non-imaging sensors or other optical components.

It is a still a further object of the present invention to provide a safety limiter and switch that is activated by a wide range of angles of impingement of damaging light or laser, for use in imaging and non-imaging sensors or other optical components.

It is a yet further object of the present invention to provide a safety limiter and switch that, when exposed to powers exceeding a limit threshold, is fast enough to intercept the damaging optical power before damage occurs, for use in imaging and non-imaging sensors or other optical components.

It is a yet further object of the present invention to provide a safety switch that, when exposed to powers exceeding an optical limit power, but lower than the optical damage threshold, is recovering to its original transparent state when exposed again to powers below the limit power, for use in imaging and non-imaging sensors or other optical components.

It is a yet further object of the present invention to provide a safety limiter and switch wherein the part in the field of view which is not exposed to powers exceeding a set threshold remains always transparent and can be viewed at all times, for use in imaging and non-imaging sensors or other optical components.

It is a still a further object of the present invention to provide a safety limiter and switch wherein the opaque spot, created by energies above the damage threshold, is permanent and can withstand long exposures to damaging light without decreasing its opacity, for use in imaging and non-imaging sensors or other optical components.

It is a still further object of the present invention to provide a limiter and safety switch that reacts to both continuous and pulsed damaging light, for use in imaging and non-imaging sensors or other optical components.

In accordance with one embodiment of the present invention, there is therefore provided an optical power limiting and switching device, comprising at least one plate made of transparent dielectric material; a thin limiting solid mixture coated on one side of the plate; wherein, upon being exposed to an optical power beam, having a power level exceeding a predetermined limit power, focused thereon the layer of limiting solid mixture limits the power transmission by scattering out part of the impinging energy. When the power is increased to a damage threshold, the solid mixture forms a plasma or catastrophic breakdown, damaging the limiting solid mixture material and thereby rendering the portion of the surface of the plate under the impinging beam opaque to light.

One particular embodiment of the invention further provides an optical power or energy limiting and switching system, comprising an optical assembly having an input unit and an output unit, each unit including a lens, the lenses being arranged to produce a common focal plane; a thin, substantially transparent layer of limiting solid mixture contacting a surface of a dielectric plate disposed at, or in proximity to, the focal plane; the layer of limiting solid mixture, when having a power level exceeding a predetermined limit power focused thereon, limits the power transmission by scattering out part of the impinging energy, and forming an electric field breakdown when exposed to optical power levels above a predetermined power damage threshold, the electric field breakdown damaging the surface of the dielectric plate, rendering the surface substantially opaque to light propagating within the optical assembly.

A specific embodiment still further provides a method for reducing or interrupting optical transmission in response to the transmission of excessive optical power or energy, the method comprising providing an optical power limiting and switching device providing an input unit and an output unit, each unit comprising a lens; positioning the lenses to form a common focal plane, and positioning a limiting solid mixture at least in close proximity to the plane; whereby transmission of a pre-determined amount of excessive power or energy impinging on the limiting solid mixture that limits the power transmission by scattering out part of the impinging energy when the power level exceeds a predetermined limit power, and forms an electric field breakdown when the power level exceeds a predetermined power damage threshold, the electric field breakdown damaging the surface of the dielectric plate, rendering the surface substantially opaque to light propagating within the optical assembly.

A particular embodiment still further provides a method for reducing or interrupting optical transmission in response to the transmission of excessive optical power or energy, the method comprising providing an optical power limiting and switching device that includes an optical-limiting solid mixture composed of light absorbing particles, smaller than the wavelength of visible light (smaller than 0.5 microns) and preferably smaller than 0.1 microns (nano-powder), dispersed in a solid matrix material. The light absorbing particles include at least one metallic or non-metallic material selected from the group consisting of: Ag, Au, Ni, Va, Ti, Co, Cr, C, Re, Si, and mixtures of such materials. The solid matrix material may be a transparent optical polymer or inorganic glass material, e.g., polymethylmethacrylate (“PMMA”) and its derivatives, epoxy resins, glass, spin-on glass (“SOG”), or other sol-gel materials. The optical limiting function begins with light absorption in the dispersed powder particles, each according to its absorption spectrum. When the absorbed light heats the particles, they conduct heat to their surroundings, leaving hot spots in the volume surrounded by them, and a decreasing temperature gradient in their neighborhood. These hot volumes can decrease the light transmission through the optical-limiting solid mixture by several mechanisms, one of which is scattering due to the refractive index spatial fluctuations created by the hot particle and its surrounding medium of a given, positive or negative, index change with temperature (dn/dT). Most of the scattered light leaves the optical path of the optical system. Some increase in the back-reflected light also may be observed. The light that is not scattered continues along the optical path having lower, “limited” power. When the incident power is reduced, the scattering volume, which surrounds each absorbing particle, diminishes. The transmittance through the optical-limiting solid mixture returns to its original value, and the scattering process decreases to negligible values. The process may be repeated many times without any permanent damage up to energies that are an order of magnitude or more, larger than the transmitted power limit.

The light-absorbing particles are dispersed in a transparent matrix such as a monomer, which is subsequently polymerized. There are many techniques for preparing such dispersions, such as with the use of dispersion and deflocculation agents added to the monomer mix. One skilled in the art of polymer and colloid science is able to prepare this material for a wide choice of particles and monomers. Similarly, techniques are well known in the art to prepare composite materials with dispersed sub-micron particles in inorganic glass matrices. When exposed to powers exceeding an optical limit power, but lower than the optical damage threshold, transparency recovers to its original transparent state when exposed again to powers below the limit power.

When the power is above the damage threshold, break down occurs. Mixtures of nano particles of conducting material in dielectrics are known to enhance the electric field strength in their vicinity where their shape and dispersion induces field concentration, resulting in lower power needed to create an electrical breakdown, and damage. Such mixtures may be modeled as a plurality of aggregates of nano-particles (see, e.g., M. Quinten, “Local Fields Close to the Surface of Nanoparticles and Aggregates of Nanoparticles,” Appl. Phys. B 73, 245-255 (2001) and the book “Absorption and Scattering of Light by Small Particles” by C. F. Bohren and D. R. Huffinann, Wiley-Interscience (1998), Chapter 12 [showing strong field enhancement factors (up to 105) for few-nanometer particles as well as wide extinction spectra for various materials and shapes]. The solid mixture forms an electric field breakdown when exposed to optical power levels above a predetermined power damage threshold. The electric field breakdown damages the surface of the solid mixture and the dielectric plate, close to it, rendering a scattering surface, substantially opaque to light propagating within the damaged spot in the optical assembly.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic, cross-sectional view of an optical power limiting and switching system for imaging and non-imaging sensors, including an optical limiter and switch according to the present invention;

FIG. 2 illustrates the method of reducing back-reflected light by tilting the optical limiter and switch;

FIG. 3 is a schematic, cross-sectional view of the optical limiter and switch of the present invention;

FIG. 4 is a schematic curve showing input and output powers to the optical limiter and switch;

FIG. 5 is a schematic view of a damaged spot on the limiter and switch and its geometrical relation to a damaging beam of light entering the switch at angle α;

FIG. 6 is an experimental curve of the limiter and switch, showing output power versus input power;

FIG. 7 is an experimental curve of the limiter and switch, showing temporal behavior;

FIG. 8 is an experimental microscopic view of a damaged (opaque) spot on the limiter and switch, showing a crater or craters at the impinging spot of the damaging light.

### DETAILED DESCRIPTION OF PREFERRED EMBODIMENTS

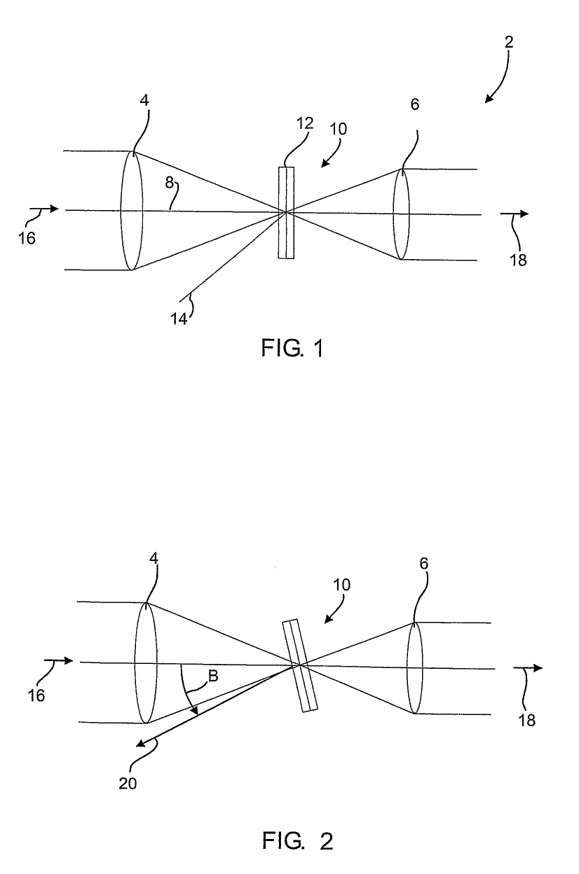

Referring now to FIG. 1, there is shown a schematic, cross-sectional view of an optical power-limiting and switching system 2 for imaging and non-imaging sensors, having a two-dimensional insert in its cross-over point. The two-dimensional optical power switching system 2 is shown utilized, e.g., with a telescope having an input lens 4 and an output lens 6, disposed along an optical path 8. An optical limiter and switch 10, responsive to optical power, is located on the optical path 8, in a plane 12 traversing the optical path. Plane 12 includes the focal or cross-over point 14, between an input power beam 16 and an output power beam 18, for causing the limiting or interruption of optical power propagation from the input power beam 16 to the output power beam 18 when the optical power exceeds a predetermined threshold.

FIG. 2 illustrates a method of reducing back-reflected light by tilting the limiter and switch 10 at an angle β/2, where β is the angle between the input power beam 16 and the reflected power beam 20. As shown, the reflected power beam 20 is outside of the field of view of the system, and cannot be transmitted back, thus minimizing the back reflection.

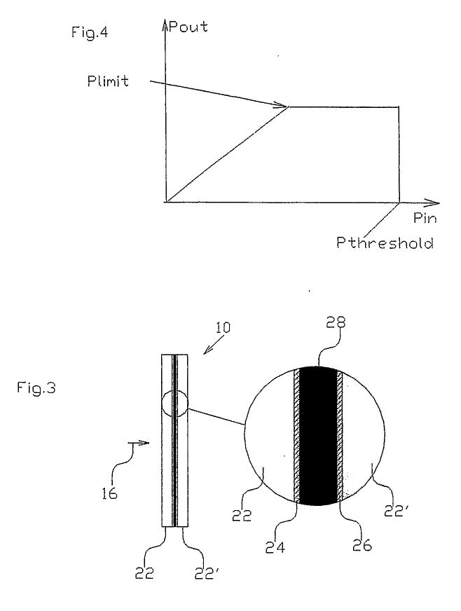

FIG. 3 is a schematic, cross-sectional view of a limiter and switch 10, for imaging and non-imaging sensors. Seen is a “sandwich” assembly, composed of two thin plates 22 and 22′, e.g., disc-shaped, made of a transparent dielectric material such as silica or Schott BK7glass, and intermediate layers 24, 26 and 28. Layer 28 is thin (few tens of microns) optical-limiting solid mixture composed of light absorbing particles, smaller than the wavelength of visible light (smaller than 0.5 microns) and preferably smaller than 0.1 microns (nano-powder), dispersed in a solid matrix material. The light absorbing particles include at least one metallic or non-metallic material selected from the group consisting of: Ag, Au, Ni, Va, Ti, Co, Cr, C, Re, Si, and mixtures of such materials. The solid matrix material may be a transparent optical polymer or inorganic glass material, e.g., polymethylmethacrylate (“PMMA”) and its derivatives, epoxy resins, glass, spin-on Glass (“SOG”), or other sol-gel materials. The optical limiting function begins with light absorption in the dispersed powder particles, each according to its absorption spectrum. When the absorbed light heats the particles, they conduct heat to their surroundings, leaving hot spots in the volume surrounded by them, and a decreasing temperature gradient in their neighborhood. These hot volumes can decrease the light transmission through the optical-limiting solid mixture by several mechanisms, one of which is scattering due to the refractive index spatial fluctuations created by the hot particle and its surrounding medium of a given, positive or negative, index change with temperature (dn/dT). Most of the scattered light leaves the optical path of the optical system. Some increase in the back-reflected light also may be observed. The light that is not scattered continues along the optical path having lower, “limited” power. When the incident power is reduced, the scattering volume, which surrounds each absorbing particle, diminishes. The transmittance through the optical-limiting solid mixture returns to its original value, and the scattering process decreases to negligible values. The process may be repeated many times without any permanent damage up to energies that are an order of magnitude or more, larger than the transmitted power limit. Layer 28 may also be covered, on one or both sides, with an anti-reflective coating, namely, an input anti-reflective coating 24 and/or an output anti-reflective coating 26. These anti-reflective coatings can significantly reduce the optical reflections from layer 28.

When optical power exceeding a predetermined damage threshold impinges upon layer 28, strong electric fields, which can lead to local electrical breakdown, are generated at particle sites. This leads to an arc-discharge, where plasma is formed. The generated plasma greatly increases the absorption of the propagating light, and the energetic discharge causes catastrophic damage at or near the particle surfaces. This damage is often viewed as cratered regions. The limiter and switch thus becomes permanently highly scattering or, in other words, highly opaque to propagating light, significantly reducing the transmitted optical power. The opacity is permanent, and creates a “blind spot” on the two-dimensional limiter and switch, thus enabling location of the direction (azimuth and elevation) of the damaging light source or laser. The device acts as a fast switch for interrupting the power propagation, which occurs as fast as the breakdown is created; it then permanently remains as an interrupting switch, at some definite spots, due to the damage formed by the energetic breakdown. The limiter and switch remains transparent in its entire area, except for the damaged spots; it is possible to view a two-dimensional image through it, with the damaged spots indicating the direction of the damaging light.

In order to control the limit power and the threshold power of the limiter and switch, several methods can be used, first, by changing the thickness of the layer 28. In general, threshold power decreases with a thicker layer. However, in this method, the transmission loss at the operating power also changes (the thicker the layer, the higher the loss). Thus, if one wants to keep a low insertion loss at the operating power, this method is rather limited in range. A second method of controlling threshold power is to use a telescope with different F-numbers, or focal spot diameters. A third and preferred method is to select the size, concentration and material of the particles in the optical-limiting solid mixture. The design and execution of the layer 28 may take into account the optimization of the limit power and threshold of the damaging power. The example given herein utilizes an optimized design.

These optical-limiting solid mixture layers were positioned at the interface between two thin silica or BK7 glass plates, and tested. Limiters and switches with limit powers of few mW and threshold powers ranging from a few tens of milli-Watts up to about a few Watts CW, as well as pulsed energy, on the crossover or focal spot of about 10-60 micrometers, were tested. The limiter and switch devices were tested for limit power, threshold power, transmission loss, return loss, added opacity after exposure to threshold and higher powers, timing, endurance and visual (microscopic) inspection before and after damage.

Visual (microscopic) inspection, after damage, revealed a cratered focal spot, the craters covering about the entire central lobe of the focal spot (where the optical power flows), and being a few microns deep.

The tests included time domain experiments, wherein limiters and switches were exposed to short pulses (few tens of microseconds, down to few tens of nanoseconds). The switches reacted in the same way as in the CW case, i.e., there was a fast, large drop in transparency when they were impinged by powers over the threshold. Initial transmissions of 80% and up were obtained. Other parameters, such as the broad-spectrum operation of the switch, as well as thresholds for angular impingement, were found satisfactory.

FIG. 4 shows an ideal schematic curve of the input and output powers of the optical limiter and switch, showing that when Pᵢₙ grows to Pₗᵢₘᵢₜ the Pₒᵤₜ grows proportionally, when Pᵢₙ grows from Pₗᵢₘᵢₜ to P_{threshold} the Pₒᵤₜ stays constant at Pₗᵢₘᵢₜ (and full transparency is recovered when Pᵢₙ is lowered), and when Pᵢₙ grows to P_{threshold} the Pₒᵤₜ is intercepted and reduced to zero.

FIG. 5 shows a schematic view of a damaged spot 30 on the switch and its geometrical relation to a damaging beam of light entering the switch at angle α. All beams 32, entering the telescope parallel to its axis of symmetry, impinge upon the focal point 14 inside switch 10. When parallel beam 32 travels at an angle a, it impinges upon point 30, which is displaced by a distance Y from point 14 on switch 10. From the geometry, it is obvious that Tana=Y/F, where F is the focal length of lens 4. Although the displacement in this example is in the vertical direction, the same rule applies to any displacement. The direction of the damaging laser beam α can be identified by looking through the system, seeing a blind spot, or by removing the damaged switch and measuring the coordinates of the damage, such as depicted in the upper part of FIG. 5.

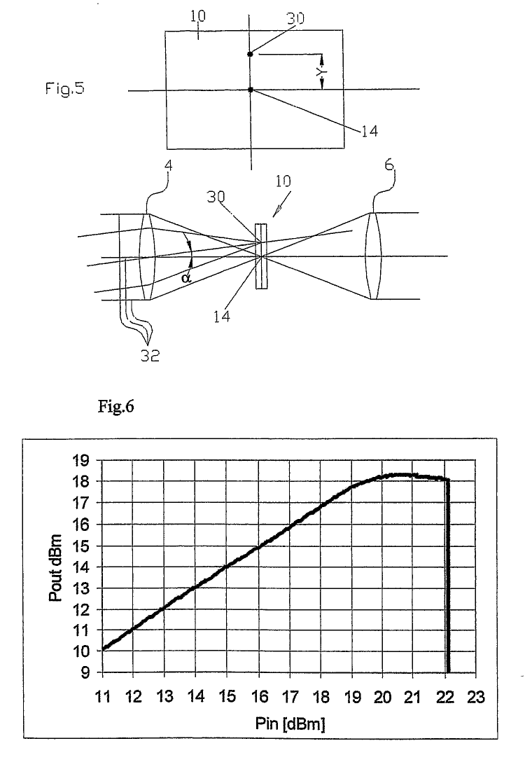

FIG. 6 is an experimental curve of a switch having a 160 mW (22 dBm) input power, showing output power versus input power. Here, the experimental results show approximately limit power of 18 dBm and damage threshold power of 22 dBm. Also, the output power dropped by approximately 30 dB when the damage occurred, reducing the output power to approximately 0.1% of the original power before the threshold power was exceeded.

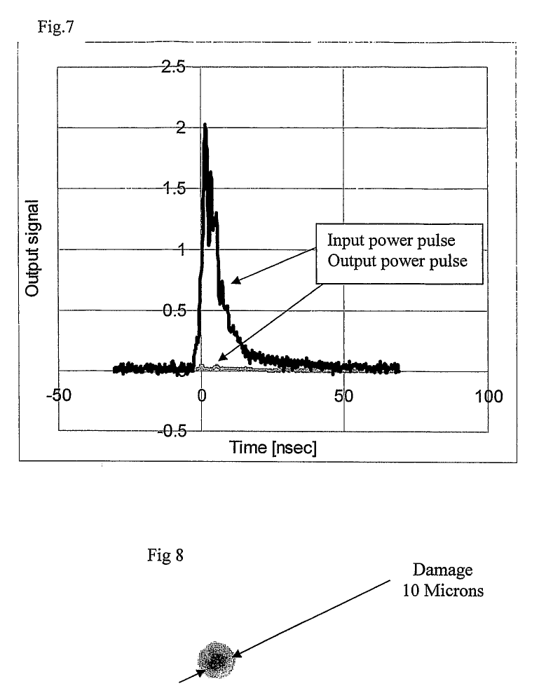

FIG. 7 is an experimental curve of switch temporal behavior, showing that when an energetic laser power (0.53 micrometer wavelength) having energy of about 14 mJ is impinged on the switch; the switch closes quickly, in less than 10 ns.

FIG. 8 is an experimental, microscopic view of a damaged (opaque) switch with a crater or craters in the impinging spot of the damaging light. The crater is seen to cover the central lobe area, where the optical ray is propagating. One can see the crater, having dimensions of about 10 micrometers in diameter.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes, which come within the meaning and range of equivalency of the claims, are therefore intended to be embraced therein.

1. An optical power limiting and switching device, comprising:
at least one plate made of transparent dielectric material;
a thin, optical-limiting solid mixture layer coated on one side of said plate, said solid mixture, upon being exposed to an optical power beam having a power level exceeding a predetermined limit power, having a constant, limited output power, and when exposed to higher threshold power focused thereon, forming a plasma that damages said mixture and dielectric material and thereby renders the portion of the surface of the plate under the impinging beam substantially opaque to light.

2. The limiting and switching device as claimed in claim 1, wherein said dielectric material is at least one material selected from the group consisting of silica, glass and Schott BK7 glass.

3. The limiting and switching device as claimed in claim 1, wherein said optical-limiting solid mixture is composed of light absorbing particles including at least one metallic or non-metallic material selected from the group consisting of: Ag, Au, Ni, Va, Ti, Co, Cr, C, Re, Si, and mixtures of such materials, smaller than the wavelength of visible light (nano-powder) dispersed in a solid matrix material.

4. The limiting and switching device as claimed in claim 3, wherein said solid matrix material is a transparent optical polymer or inorganic glass material.

5. The limiting and switching device as claimed in claim 3, wherein said solid matrix material is at least one material selected from the group consisting of polymethylmethacrylate (“PMMA”) and its derivatives, epoxy resins, glass, spin-on glass (“SOG”)and other sol-gel materials.

6. The limiting and switching device as claimed in claim 1, further comprising an anti-reflective layer interposed between said plate and said optical-limiting solid mixture layer.

7. The limiting and switching device as claimed in claim 1, wherein said optical-limiting solid mixture layer is coated on both of its surfaces with an anti-reflective material and is interposed between two transparent, dielectric material plates.

8. The limiting and switching device as claimed in claim 1, further comprising an input unit and an output unit, each unit comprising a lens;
said units or said lenses being disposed to form a common focal plane, and said optical-limiting solid mixture layer being located at least in close proximity to said plane.

9. An optical power or energy limiting and switching system, comprising:
an optical assembly having an input unit and an output unit, each unit including a lens, said lenses being arranged to produce a common focal plane;
a thin, substantially transparent layer of optical-limiting solid mixture contacting a surface of a dielectric plate disposed at, or in proximity to, said focal plane;
said layer of optical-limiting solid mixture forming an electric field breakdown when exposed to optical power levels above a predetermined threshold, said electric field breakdown damaging the surface of the dielectric plate, rendering the surface substantially opaque to light propagating within said optical assembly.

10. The limiting and switching system as claimed in claim 9, wherein said optical-limiting solid mixture is disposed between the surfaces of two transparent dielectric plates.

11. The limiting and switching system as claimed in claim 9, further comprising an anti-reflective layer between said layer of optical-limiting solid mixture and said dielectric plate.

12. The limiting and switching system as claimed in claim 9, wherein the plane of said dielectric plate is tilted with respect to the axis of propagation of a light beam, to reduce the back-reflected light impinging on said switch.

13. A method for limiting and/or interrupting optical transmission in response to the transmission of excessive optical power or energy, said method comprising:
providing an optical power limiting and switching device as claimed in claim 1;
providing an input unit and an output unit, each unit comprising a lens;
positioning said lenses to form a common focal plane, and positioning said optical-limiting solid mixture at least in close proximity to said plane;
whereby transmission of a pre-determined amount of excessive power or energy impinging on the optical-limiting solid mixture forms a limiting action when exposed to powers between Pₗᵢₘᵢₜ and P_{threshold} and an electric field breakdown when exposed to powers greater than P_{threshold}, damaging the dielectric plate and thereby rendering it substantially opaque to light.

14. The method as claimed in claim 13, further comprising the step of:
coating said optical limiting solid mixture with an anti-reflective material.

15. The method as claimed in claim 13, wherein said transparent dielectric material is at least one material selected from the group consisting of silica, glass and Schott BK7glass.

16. The method as claimed in claim 13, wherein said optical limiting solid mixture is composed of light absorbing particles, include at least one metallic or non-metallic material selected from the group consisting of: Ag, Au, Ni, Va, Ti, Co, Cr, C, Re, Si, and mixtures of such materials,. smaller than the wavelength of visible light (nano-powder) dispersed in a solid matrix material.

17. The method as claimed in claim 16, wherein said solid matrix material is a transparent optical polymer or inorganic glass material.

18. The method as claimed in claim 16, wherein said solid matrix material is at least one material selected from the group consisting of polymethylmethacrylate (“PMMA”) and its derivatives, epoxy resins, glass, spin-on glass (“SOG”)and other sol-gel materials.
